(19) United States
(12) Patent Application Publication
(10) Pub. No.: US 2022/0266659 A1
(43) Pub. Date: Aug. 25, 2022

(54) HEATER FOR HEATING A HEAT TRANSFER MEDIUM, ESPECIALLY IN A VEHICLE

(71) Applicants: Eberspächer catem GmbH & Co. KG, Herxheim (DE); Eberspächer catem Hermsdorf GmbH & Co. KG, Hermsdorf (DE)

(72) Inventors: Florian BITTO-GOLON, Remse (DE); Dietmar WUNSTORF, Hildesheim (DE); Steffen REINECKE, Zwickau (DE)

(21) Appl. No.: 17/677,527

(22) Filed: Feb. 22, 2022

(30) Foreign Application Priority Data
Feb. 23, 2021 (DE) 10 2021 104 263.1

(51) Int. Cl. B60H 1/22; H05B 3/12; B60H 1/00

(52) U.S. Cl. CPC B60H 1/2225; H05B 3/12; B60H 1/00564; H05B 2203/02; H05B 2203/017; H05B 2203/016; H05B 2203/023; H05B 2203/024; B60H 2001/224; H05B 2203/007

(57) ABSTRACT

A heater (10) for heating a heat transfer medium, especially in a vehicle, with at least one heating element (14) built up with PTC material with a plurality of heat transfer medium flow ducts (30) passing through the heating element (14).

### CROSS REFERENCE TO RELATED APPLICATIONS

This application claims the benefit of priority under 35 U.S.C. § 119 of German Application DE 10 2021 104 263.1, filed Feb. 23, 2021, the entire contents of which are incorporated herein by reference.

### TECHNICAL FIELD

The present invention pertains to a heater for heating a heat transfer medium, for example, the air to be introduced into an interior of a vehicle.

### TECHNICAL BACKGROUND

Electrically operated heaters have increasingly been used in vehicle construction above all in connection with vehicles operated with electric motors only or with hybrid vehicles in order to provide, for example, the thermal energy necessary for heating the interior of the vehicle. For example, positive temperature coefficient (PTC) heaters or so-called PTC heaters are used for this purpose in order to transfer thermal energy to the heat transfer medium by a heat transfer medium, for example, the air to be introduced into an interior of the vehicle, flowing around PTC heating elements provided therein. The PTC heating elements, which have, in general, a block-like configuration, are arranged here between different components or material layers which carry these and also contact these electrically, as a result of which the efficiency of heat transfer to the medium to be heated is also compromised based on the thermal shielding of the PTC heating elements, which shielding is introduced thereby as well.

### SUMMARY

An object of the present invention is to provide an electrically operated heater for heating a heat transfer medium, especially in a vehicle, which heat transfer medium has an increased efficiency of heat transfer to the medium to be heated.

This object is accomplished according to the present invention by a heater for heating a heat transfer medium, especially in a vehicle, according to the invention. This heater comprises at least one heating element built with PTC material with a plurality of flow ducts passing through the heating element.

Due to the provision of the heating element or of at least one heating element built with PTC material such that this heating element has a plurality of ducts, which pass through the heating element and the heat transfer medium can thus flow through them, a comparatively large surface is provided, at which a direct heat transfer contact, which is not shielded by additional components, is formed between the medium to be heated and the PTC material of the heating element. This leads to a high efficiency in the transfer of thermal energy provided by electrical energization of the PTC material of the heating element to the heat transfer medium to be heated.

In order to make it possible to utilize the volume provided in the heating element efficiently for the flow with a low flow resistance, it is proposed that the heat transfer medium flow ducts extend in the heating element between an incoming flow end face and an outflow end face essentially parallel to one another.

In particular, provisions may be made for at least one heat transfer medium flow duct, preferably each heat transfer medium flow duct, to have a cross-sectional geometry essentially not changing in the longitudinal direction of the flow duct or/and a cross-sectional dimension essentially not changing in a longitudinal direction of the flow duct.

For the adaptation to different geometries of the system areas carrying the heat transfer medium to be heated, at least one heat transfer medium flow duct and preferably each heat transfer medium flow duct may have in another embodiment a cross-sectional geometry changing in a longitudinal direction of the flow duct or/and a cross-sectional dimension changing in a longitudinal direction of the flow duct.

To define the different heat transfer medium flow ducts in the heating elements, at least two heat transfer medium flow ducts may be defined by a flow duct partition of the heating element, which said partition separates these flow ducts, or/and at least one heat transfer medium flow duct may be defined by a heating element outer wall.

It is proposed for a stable configuration, which can be embodied in a simple manner and yet is stable, that at least some of the flow duct partitions and preferably all flow duct partitions or/and heating element outer walls provide a heating element structure formed from a block of material. An essentially monolithic structure of the heating element is thus used, which guarantees a good structural connection and prevents leakages of the heat transfer medium from the heat transfer medium flow ducts even in case of comparatively more complex geometry of the heat transfer medium flow ducts.

A configuration that can be embodied in a simple manner can be obtained by at least some and preferably all of the flow duct partitions or/and heating element outer walls having an essentially constant wall thickness in a flow duct circumferential direction or/and in a flow duct longitudinal direction. It is, of course, possible, for example, if increased mechanical loads may occur in certain areas of the heating element, to provide flow duct partitions or heating element outer walls provided in such areas with varying, especially greater or increasing wall thickness.

The provision of the heating element with essentially constant wall thickness can be embodied easily, for example, if at least one heat transfer medium flow duct and preferably each heat transfer medium flow duct has a polygonal cross-sectional geometry.

A stable configuration of the heating element with a nevertheless large volume of the heat transfer medium flow ducts and with a large heat transfer area of the heating element can be obtained, for example, by at least some of the heat transfer medium flow ducts forming a honeycomb-like (a honeycomb shape) opening structure.

For example, barium titanate may be used as the PTC material for forming the structure of the heating element.

In order to make it possible to generate heat in the heating element by electrical energization, contact elements may be provided at the heating element for electrically contacting the heating element.

A structure of the heating element, which is provided by a block of material, i.e., an essentially monolithic structure of the heating element, may be provided, for example, by the heating element being manufactured in a layer application process, for example, in a 3D screen printing process, with a plurality of PTC material layers applied one after another in a flow duct longitudinal direction. It becomes possible with such a layer application process to change the cross-sectional geometry of the heating element, i.e., of the flow duct partitions or heating element outer walls defining the individual heat transfer medium flow ducts through the heating element by consecutively building up the heating element, for example, in the flow duct longitudinal direction, so that the heat transfer medium flow ducts can be provided with essentially any freely selectable cross-sectional geometry or cross-sectional dimension changing over the course of the heat transfer medium flow ducts.

For accommodating the at least one heating element, the heater may have a housing. The at least one heating element is configured and arranged in this housing such that heat transfer medium to be heated can flow through the heat transfer medium flow ducts provided in the at least one heating element.

To achieve a further enlargement of the surface available for the heat transfer, at least one heating element may be configured and arranged in the housing such that heat transfer medium to be heated can flow around at an outer surface of at least one heating element outer wall. As an alternative or in addition, at least two heating elements may be configured and arranged in the housing for parallel flow or/and at least two heating elements may be arranged for serial flow.

The present invention further pertains to a heating element for a heater, especially for a heater configured according to the present invention, wherein the heating element is formed with PTC material and has a plurality of heat transfer medium flow ducts passing through this heating element. It should be noted that such a heating element may have all the heating element structural features explained above individually or in any combination.

In particular, provisions may be made, for example, for at least two heat transfer medium flow ducts in the heating element to be defined by a flow duct partition of the heating element, which said partition separates these heat transfer medium flow ducts or/and for at least one heat transfer medium flow duct to be defined by a heating element outer wall, and for at least some and preferably all of the flow duct partitions or/and heating element outer walls to provide a heating element structure formed by a block of material.

The present invention pertains, furthermore, to a process for manufacturing such a heating element with a plurality of heat transfer medium flow ducts extending in the heating element, for example, for a heater configured according to the present invention, in which process the heating element is built up by consecutively applying to one another PTC material layers following one another, for example, in a flow duct longitudinal direction.

For example, the heating element may be manufactured with a 3D screen printing process.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view showing a heater for heating a heat transfer medium.

### DESCRIPTION OF PREFERRED EMBODIMENTS

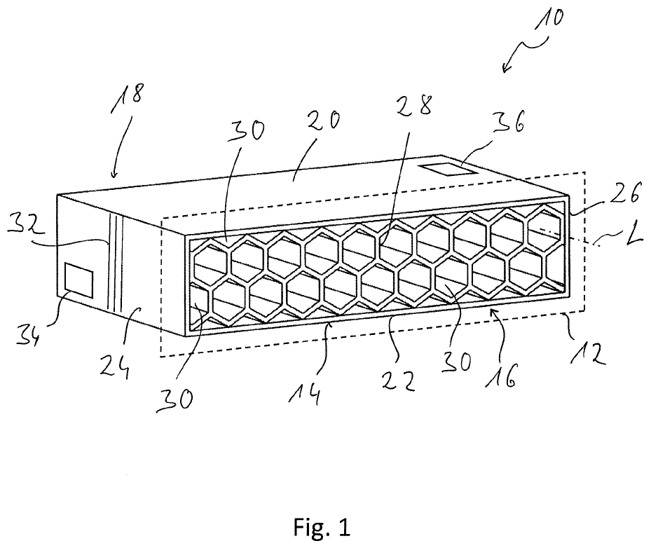

The heater 10 shown in FIG. 1 comprises, for example, a housing 12, which is made, for example, from a plastic material, is shown in FIG. 1 only by way of dash line, and which may be integrated, for example, in an air guide system, in which the air to be introduced into an interior of a vehicle is guided in a vehicle.

A heating element 14 built with PTC material is arranged in the housing 12. The cross-sectional geometry of the heating element 14 is adapted in this case to the cross-sectional geometry of the housing 12 and of the air guide system, into which the heater 10 is to be integrated. The heating element 12 has an essentially cuboid outer contour in the example shown.

The heating element 14 has four heating element outer walls 20, 22, 24, 26, which define its inner volume and extend between an incoming flow end face 16 shown located in the front in FIG. 1 and an outflow end face 18 located in the rear in FIG. 1. To provide the cuboid outer contour of the heating element 14, the heating element outer walls 20, 22 and 24, 26 are located in pairs parallel opposite each other and adjoin each respective heating element outer walls located directly adjacent to one another at an angle of about 90° .

In conjunction with the heating element outer walls 20, 22, 24, 26, a plurality of flow duct partitions 28 define a plurality of heat transfer medium flow ducts 30 in the interior of the heating element 14. The heat transfer medium flow ducts 30 extend in the heating element 14 between the incoming end face 16 and the outflow end face 18 essentially parallel to one another and in a straight line in a flow duct longitudinal direction L. The heat transfer medium flow ducts 30 are open at the incoming flow end face 16 to receive the heat transfer medium to be heated and are open at the outflow end face 18 for releasing the heat transfer medium heated during the heating operation of the heater 10.

FIG. 1 shows an embodiment of the heating element 14, in which a polygonal, honeycomb-like cross-sectional geometry of the heat transfer medium flow ducts 30 is provided by the flow duct partitions 28 and by the heating element outer walls 20, 22, 24, 26. Each of the heat transfer medium flow ducts 30 provided with an essentially hexagonal cross-sectional geometry is defined here by six partitions 28. Based on the cuboid outer contour of the heating element 14, there also are heat transfer medium flow ducts which have no hexagonal cross-sectional geometry but have, for example, a triangular or trapezoidal/rectangular cross-sectional geometry.

In the exemplary embodiment shown, all flow duct partitions 28 have an essentially constant wall thickness in the circumferential direction around a respective heat transfer medium flow duct 30 and in the flow duct longitudinal direction L. The heating element outer walls 20, 22, 24, 26 also have an essentially constant and mutually equal wall thickness, which may correspond to the wall thickness of the flow duct partitions 28, in the flow duct longitudinal direction L and at right angles thereto. This causes the heat transfer medium flow ducts 30 provided in the heating element 14 to have an essentially constant cross-sectional dimension in the flow duct longitudinal direction L and to preferably also have an essentially cylindrical shape, which is achieved by an inlet opening of the respective heat transfer medium flow ducts 30, which is formed at the incoming flow end face 16, and by an outflow opening of the respective heat transfer medium flow ducts 30, which said outflow opening is formed at the outflow end face 18, to be congruent in relation to one another, i.e., not to be offset at right angles to the flow duct longitudinal direction L.

All flow duct partitions 28 and all heating element outer walls 20, 22, 24, 26 form a structure of the heating element 14, which structure is formed from a block of material and is built up solidly (as a monolith) with PTC material. In other words, the heating element 14 is not composed of respective different individual parts partially defining the heat transfer medium flow ducts 30, but it forms essentially a monolithic structure or forms a monolithic structure. This can be achieved, for example, by a plurality of layers 32 of the PTC material, which are illustrated in FIG. 1, being applied to one another in the flow duct longitudinal direction L of the flow ducts 30 to be formed in a layer application process. For example, a 3D screen printing process may be used for such a layer application process, with which the individual layers 32 of the PTC material, for example, barium titanate (BaTiO₃) are applied one after another, so that a connection formed by connection is substance is formed between the individual layers 32 applied consecutively and an actual monolithic structure of the heating element 14 is obtained.

It becomes possible with the use of such a layer application process to produce the heating element 14 with essentially any freely selectable cross-sectional geometry, especially also with any freely selectable cross-sectional geometry of the heat transfer medium flow ducts 30 in the interior of the heating element 14, wherein, as in the example shown, the cross-sectional geometry and the cross-sectional dimension of the heating element 14 and of the heat transfer medium flow ducts 30 formed therein may be essentially equal in the flow duct longitudinal direction L, i.e., between the incoming flow end face 16 and the outflow end face 18, or they may change when needed in the flow duct longitudinal direction L. For example, a wound or curved course of the heat transfer medium flow ducts 30 may thus also be provided in the interior of the heating element 14, or, as an alternative or in addition, the heat transfer medium flow ducts 30 may have a varying cross-sectional dimension or/and cross-sectional geometry in the interior of the heating element 14.

A large surface, at which the heat transfer medium flowing through the heat transfer medium flow ducts 30 can absorb heat, is provided in the interior of the heating element 14 with the configuration according to the present invention of a heating element 14 with a plurality of heat transfer medium flow ducts 30 passing through this heating element 14. A highly efficient heat transfer, in which the outer surface of the heating element 14, i.e., the outer surface of the heating element outer walls 20, 22, 24, 26, is not used or is not necessarily used for the transfer of heat to the heat transfer medium flowing through the heating element 14, is thus guaranteed. It is nevertheless also possible, in principle, to position the heating element 14 in the housing 12 such that flow takes place through this heating element 14 not only in the area of the heat transfer medium flow ducts 30, but also around the outer side of the outer walls 20, 22, 24, 26 in order to make it possible to use this surface for the heat transfer as well.

In order to make it possible to provide heat by an electrical energization of the heating element 14 built with PTC material, electrical contacts 34, 36 are provided at two areas of the heating element 14, which are located at spaced locations from one another, for example, on outer sides of two heating element outer walls. These may be provided, for example, by applying metallic material. In the area of these electrical contacts 34, 36, the heating element 14 can be brought into connection with a voltage source by attaching lines by soldering or by a pressure contact with contact pins or the like in order to generate heat by applying an electrical voltage and by the current flow generated thereby through the heating element 14.

It should be noted that the heater 10 and its heating element 14 can be varied in many different manners by using the configuration principles of the present invention. Thus, the heat transfer medium flow ducts 30 may, of course, have a cross-sectional geometry different from that shown. For example, these may have a triangular, rectangular or even a round cross-sectional geometry. The heating element 14 may correspondingly also have a cross-sectional geometry different from the rectangular cross-sectional geometry shown. A plurality of heating elements 14 may also be arranged, for example, next to one another or/and following one another in the flow direction in the housing 12 in the heater 10 according to the present invention. A serial or parallel flow arrangement may be provided by such a configuration and arrangement of the plurality of heating elements 14. The electrical contacts 34, 36 may also be provided at a different position at the heating element 14, in which case the positioning of the electrical contacts 34, 36 may be predefined. for example, by the location at which passages are arranged in the housing 12 for the electrical lines leading to a voltage source.

While specific embodiments of the invention have been shown and described in detail to illustrate the application of the principles of the invention, it will be understood that the invention may be embodied otherwise without departing from such principles.

What is claimed is:

1. A heater for heating a heat transfer medium, the heater comprising:
a heating element formed with PTC material; and
a plurality of heat transfer medium flow ducts passing through the heating element.

2. The heater in accordance with claim 1, wherein the heat transfer medium flow ducts extend in the heating element essentially parallel to one another between an incoming flow end face and an outflow end face.

3. The heater in accordance with claim 1, wherein:
at least one of the heat transfer medium flow ducts has a cross-sectional geometry which essentially does not change in a flow duct longitudinal direction; or
at least one of the heat transfer medium flow ducts has a cross-sectional dimension essentially not changing in a flow duct longitudinal direction; or
at least one of the heat transfer medium flow ducts has a cross-sectional geometry which essentially does not change in a flow duct longitudinal direction and has a cross-sectional dimension essentially not changing in a flow duct longitudinal direction.

4. The heater in accordance with claim 1, wherein:
at least one of the heat transfer medium flow ducts has a cross-sectional geometry changing in a flow duct longitudinal direction; or
at least one of the heat transfer medium flow ducts has a cross-sectional dimension changing in a flow duct longitudinal direction; or
at least one of the heat transfer medium flow ducts has a cross-sectional geometry changing in a flow duct longitudinal direction and has a cross-sectional dimension changing in a flow duct longitudinal direction.

5. The heater in accordance with claim 1, wherein:
at least two of the heat transfer medium flow ducts are defined by a flow duct partition of the heating element, which partition separates the at least two of the heat transfer medium flow ducts; or
at least one of the heat transfer medium flow ducts is defined by a heating element outer wall; or
at least two of the heat transfer medium flow ducts are defined by a flow duct partition of the heating element, which partition separates the at least two of the heat transfer medium flow ducts and at least one of the heat transfer medium flow ducts is defined by a heating element outer wall.

6. The heater in accordance with claim 5, wherein at least one of the flow duct partition and the heating element outer wall provides a heating element structure formed from a block of material.

7. The heater in accordance with claim 5, wherein:
at least one of the flow duct partition and the heating element outer wall have an essentially constant wall thickness in a flow duct circumferential direction; or
at least one of the flow duct partition and the heating element outer wall have an essentially constant wall thickness in a flow duct longitudinal direction.

8. The heater in accordance with claim 1, wherein at least one of the heat transfer medium flow ducts has a polygonal cross-sectional geometry.

9. The heater in accordance with claim 8, wherein at least some of the heat transfer medium flow ducts form a honeycomb shape opening structure.

10. The heater in accordance with claim 1, wherein the PTC material comprises barium titanate.

11. The heater in accordance with claim 1, further comprising contact elements provided at the heating element for an electrical contacting of the heating element.

12. The heater in accordance with claim 1, wherein the heating element is manufactured in a layer application process, with a plurality of PTC material layers following one another.

13. The heater in accordance with claim 12, wherein the layer application process comprises a 3D screen printing process.

14. The heater in accordance with claim 1, further comprising a housing accommodating the heating element, wherein the heating element is configured and arranged in the housing such that a heat transfer medium to be heated flows through the heat transfer medium flow ducts provided in the at least one heating element.

15. The heater in accordance with claim 14, wherein:
the heating element is configured and arranged in the housing such that heat the transfer medium to be heated flows around the heating element at an outer surface of the heating element outer wall; or
the heater further comprises another heating element to provide at least two heating elements configured and arranged in the housing for a parallel flow; or
the heater further comprises another heating element to provide at least two heating elements configured and arranged in the housing for a serial flow; or
any combination of the heating element is configured and arranged in the housing such that heat the transfer medium to be heated flows around the heating element at an outer surface of the heating element outer wall, and the heater further comprises another heating element to provide at least two heating elements configured and arranged in the housing for a parallel flow; and the heater further comprises another heating element to provide at least two heating elements configured and arranged in the housing for a serial flow.

16. A heating element for a heater for heating a heat transfer medium, the heater comprising a heating element and a plurality of heat transfer medium flow ducts, wherein:
the heating element is formed of PTC material; and
the heating element is configured to have the plurality of heat transfer medium flow ducts passing therethrough.

17. The heating element in accordance with claim 16, wherein:
at least two of the heat transfer medium flow ducts are defined by a flow duct partition of the heating element, which separates the at least two of the heat transfer medium flow ducts, or at least one of the heat transfer medium flow ducts is defined by a heating element outer wall, or at least two of the heat transfer medium flow ducts are defined by a flow duct partition of the heating element, which separates the at least two of the heat transfer medium flow ducts and at least one of the heat transfer medium flow ducts is defined by a heating element outer wall; and
at least one of the flow duct partition and the heating element outer wall provides a heating element structure formed from a block of material.

18. A process for manufacturing a heating element of a heater for heating a heat transfer medium, wherein the heater comprises the heating element formed with PTC material and a plurality of heat transfer medium flow ducts passing through the heating element, the process comprising building up the heating element by consecutively applying PTC material layers following one another.

19. The process according to claim 18, wherein the PTC material layers are applied following one another in a flow duct longitudinal direction.

20. The process according to claim 19, wherein the PTC material layers are applied with a 3D screen printing process.
